(19) United States
(12) Patent Application Publication
(10) Pub. No.: US 2007/0046181 A1
(43) Pub. Date: Mar. 1, 2007

(54) ORGANIC ELECTROLUMINESCENCE DEVICE

(76) Inventors: An-Chi Wei, Keelung City (TW); Han-Ping Shieh, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,774

(22) Filed: Feb. 21, 2006

(30) Foreign Application Priority Data
Aug. 23, 2005 (TW) 94128698

(51) Int. Cl. H01J 1/62; H01J 63/04

(52) U.S. Cl. 313/504

(57) ABSTRACT

An organic electroluminescence device including a substrate, a metal electrode layer, an organic light emission layer, a transparent electrode layer, a passivation layer and a lens is provided. The metal electrode layer is disposed on the substrate, and the organic light emission layer is disposed on the metal electrode layer. The transparent electrode layer is disposed on the organic light emission layer. The passivation layer is disposed on the transparent electrode layer, and the lens is disposed on the passivation layer. Moreover, the lens has a top surface, a bottom surface opposite to the top surface, and multiple banding surfaces connected between the top surface and the bottom surface. A discontinuous surface is composed of the banding surfaces. The banding surfaces are inclined surfaces and the angle between the bottom surface and the banding surface closer to the bottom surface is larger.

### CROSS-REFERENCE TO RELATED APPLICATION

This application claims the priority benefit of Taiwan application serial no. 94128698, filed on Aug. 23, 2005. All disclosure of the Taiwan application is incorporated herein by reference.

### BACKGROUND OF THE INVENTION

1. Field of Invention

The present invention relates to a luminescence device. More particularly, the present invention relates to an organic electroluminescence device.

2. Description of Related Art

FIG. 1 schematically shows a cross-sectional view of a conventional top-emission organic electroluminescence device. Referring to FIG. 1, the conventional organic electroluminescence device 100 consists of a lower substrate 110, a metal anode 120, an organic light emission layer 130, a transparent cathode layer 140, and an upper substrate 150. The metal anode 120 is disposed on the lower substrate 110, the organic light emission layer 130 disposed on the metal anode 120, and the transparent cathode layer 140 disposed between the upper substrate 150 and the organic light emission layer 130. When a bias voltage is applied across the metal electrode layer 120 and transparent electrode layer 140, the electron is transmitted to the organic light emission layer 130 from the transparent electrode layer 140. On the other hand, the hole is transmitted to the organic light emission layer 130 from the metal electrode layer 120. At this time, the recombination phenomenon of the electron and hole occurs in the organic light emission layer 130, and the exciter is generated to offer light emission effect accordingly.

As described above, though the lights 132 emitted by the organic light emission layer 130 are directed in all directions, the lights 132 scattered downwards are reflected by the metal anode 120 and therefore the conventional organic electroluminescence device 100 is of top emission type. However, as the refractive index of the upper substrate 150 is larger than the refractive index of air, light is lost through total reflection into the wave-guiding modes in the upper substrate 150 when irradiating into air from the upper substrate 150 with an incident angle larger than the total reflection angle. Therefore, a part of the lights 132 emitted by the organic light emission layer 130 cannot be coupled out from the upper substrate 150, thereby affecting the coupling efficiency of the organic electroluminescence device 100.

### SUMMARY OF THE INVENTION

The object of present invention is to provide a top-emission organic electroluminescence device with a higher out-coupling efficiency.

Another object of the present invention is to provide a bottom-emission organic electroluminescence device with a higher out-coupling efficiency.

The present invention provides an organic electroluminescence device comprising a substrate, a metal electrode layer, an organic light emission layer, a transparent electrode layer, a passivation layer, and a lens. The metal electrode layer is disposed on the substrate, and the organic light emission layer disposed on the metal electrode layer and suitable for emitting a light. The transparent electrode layer is disposed on the organic light emission layer, the passivation layer disposed on the transparent electrode layer, and the lens disposed on the passivation layer. Besides, the lens has a top surface and a bottom surface which are opposite to each other, and multiple banding surfaces which are connected between the top surface and the bottom surface and they form a discontinuous surface. These banding surfaces are inclined surfaces, and the angle between the banding surface closer to the bottom surface and the bottom surface is larger.

In the organic light emission device mentioned above, for example, although the contour of the interface where the organic light emission layer and the transparent electrode layer are connected is a rectangle, the contours of the top and the bottom surfaces of the lens are a circle, and the contour of a section of each banding surface parallel with the bottom surface is a circle. Besides, the incident angles of the lights emitting from the organic light emission layer on the top surface and each banding surface, for example, are smaller than or equal to the total reflection angle between the lens and the air at a section which is perpendicular to the bottom of the lens, through the center of the rectangle and parallel with an edge of the rectangle.

In the organic light emission device mentioned above, for example, the contour of the interface where the organic light emission layer and the transparent electrode layer are connected is a rectangle, the contour of the top surface and the bottom surface of the lens is a rectangle, and the contour of a section of each of the banding surfaces parallel with the bottom surface is a rectangle. Besides, the incident angles of the lights emitted from the organic light emission layer on the top surface and each of the banding surfaces, for example, are smaller than or equal to the total reflection angle between the lens and the air at a section which is perpendicular to the bottom of the lens, through the center of the rectangle and parallel with an edge of the rectangle.

In the organic light emission device mentioned above, the material of the lens is transparent material, for example. In addition, the transparent material is polycarbonate (PC) or polymethyl methacrylate (PMMA), for example.

The organic light emission device mentioned above may further includes a hole transport layer disposed between the metal electrode layer and the organic light emission layer or between the transparent electrode layer and the organic light emission layer.

The organic light emission device mentioned above may further include an electron transport layer disposed between the transparent electrode layer and the organic light emission layer or between the metal electrode layer and the organic light emission layer.

The present invention further provides an organic electroluminescence device comprising a substrate, a transparent electrode layer, an organic light emission layer, a metal electrode layer, and a lens. The transparent electrode layer is disposed on a first surface of the substrate. The organic light emission layer is disposed on the transparent electrode layer and suitable for emitting a light. The metal electrode layer is disposed on the organic light emission layer, and the lens disposed on a second surface of the substrate wherein the second surface and the first surface are opposite. Besides, the lens has a top surface and a bottom surface which are opposite to each other, and multiple banding surfaces which are connected between the top surface and the bottom surface. These banding surfaces form a discontinuous surface and they are inclined surfaces. Also, the angle between the banding surface which is closer to the bottom surface and the bottom surface is larger.

In the organic light emission device mentioned above, for example, the contour of the interface where the organic light emission layer and the transparent electrode layer are connected is a rectangle, the contour of the top surface and the bottom surface of the lens is a circle, and the contour of a section of each of the banding surfaces parallel with the bottom surface is a circle. Besides, the incident angles of the lights emitted from the organic light emission layer on the top surface and each of the banding surfaces, for example, are smaller than or equal to the total reflection angle between the lens and the air at a section which is perpendicular to the bottom of the lens, through the center of the rectangle and parallel with an edge of the rectangle.

In the organic light emission device mentioned above, for example, the contour of the interface where the organic light emission layer and the transparent electrode layer are connected is a rectangle, the contour of the top surface and the bottom surface of the lens is a rectangle, and the contour of a section of each of the banding surfaces parallel with the bottom surface is a rectangle. Besides, the incident angles of the lights emitted from the organic light emission layer on the top surface and each of the banding surfaces, for example, are smaller than or equal to the total reflection angle between the lens and the air at a section which is perpendicular to the bottom of the lens, through the center of the rectangle and parallel with an edge of the rectangle.

In the organic light emission device mentioned above, the material of the lens is transparent material, for example. In addition, the transparent material is polycarbonate (PC) or polymethyl methacrylate (PMMA), for example.

The organic light emission device mentioned above may further includes a hole transport layer disposed between the metal electrode layer and the organic light emission layer or between the transparent electrode layer and the organic light emission layer.

The organic light emission device mentioned above may further include an electron transport layer disposed between the transparent electrode layer and the organic light emission layer or between the metal electrode layer and the organic light emission layer.

In the organic light emission device provided by the present invention, because most of the lights emitted by the organic light emission layer on top surface of the lens and banding surfaces are not subject to the total reflection. That is, most of the lights can transmit through the top surface of the lens and the banding surfaces. Therefore, the organic light emission device of the present invention can have a higher coupling efficiency.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a cross-sectional view of a conventional organic electroluminescence device.

FIG. 2 schematically shows a cross-sectional view of an organic electroluminescence device according to the first embodiment of the present invention.

FIG. 3 schematically shows a top view of the lens in the first embodiment of the present invention.

FIGS. 4A to 4C schematically illustrate how the shape of the lens shown in FIG. 2 is determined.

FIG. 5 schematically shows a cross-sectional view of another organic electroluminescence device according to the first embodiment of the present invention.

FIG. 6 schematically shows a cross-sectional view of another organic electroluminescence device according to the second embodiment of the present invention.

### DESCRIPTION OF THE PREFERRED EMBODIMENTS

### The First Embodiment

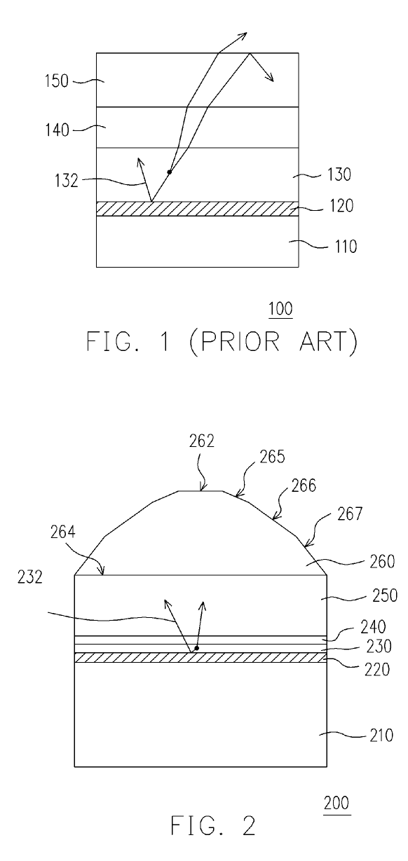

FIG. 2 schematically shows a cross-sectional view of an organic electroluminescence device according to the first embodiment of the present invention. Referring to FIG. 2, the organic electroluminescence device 200 of the present embodiment comprises a substrate 210, a metal electrode layer 220, an organic light emission layer 230, a transparent electrode layer 240, a passivation layer 250, and a lens 260. The metal electrode layer 220 is disposed on the substrate 210, and the organic light emission layer 230 disposed on metal electrode layer 220 and suitable for emitting a light 232. The transparent electrode layer 240 is disposed on the organic light emission layer 230, the passivation layer 250 disposed on the transparent electrode layer 240, and the lens 260 disposed on the passivation layer 250. Besides, the lens 260 has a top surface 262 and a bottom surface 264 which are opposite to each other and multiple banding surfaces (e.g. the banding surfaces 265, 266, and 267) connected between the top surface 262 and the bottom surface 264. The banding surfaces form a discontinuous surface. These banding surfaces 265, 266, and 267 are inclined surfaces, and the angle between the banding surface closer to the bottom surface 264 and the bottom surface 264 is the largest. Namely, the angle between the banding surface 267 and the bottom surface 264 is larger than the angle between the banding surface 266 and the bottom surface 264, and the angle between the banding surface 266 and the bottom surface 264 is larger than that between the banding surface 265 and the bottom surface 264.

In the organic electroluminescence device 200 mentioned above, the material of the substrate 210 is glass for example. The material of the transparent electrode layer 240 is indium tin oxide (ITO), indium zinc oxide (IZO) or other transparent conductive materials, for example. In addition, the material of the lens 260 for example is transparent material, such as Polycarbonate (PC), Polymethyl Methacrylate (PMMA) and so on. The material of the passivation layer 250 selected may be of high transparency. Further, the metal electrode layer 220 is an anode and the transparent electrode layer 240 is a cathode, for example.

In the present embodiment, when a bias voltage is applied across the metal electrode layer 220 and transparent electrode layer 240, the electron is transmitted to the organic light emission layer 230 from the transparent electrode layer 240. On the other hand, the hole is transmitted to the organic light emission layer 230 from the metal electrode layer 220. At this time, the recombination phenomenon of the electron and the hole occurs in the organic light emission layer 230, and the exciter is generated to offer light emission effect accordingly. Additionally, though the light 132 emitted by the organic light emission layer 230 is directed in all directions, the light 132 emitting downwards is reflected by the metal electrode 220 and therefore the organic electroluminescence device 200 of the present embodiment is of top emission type.

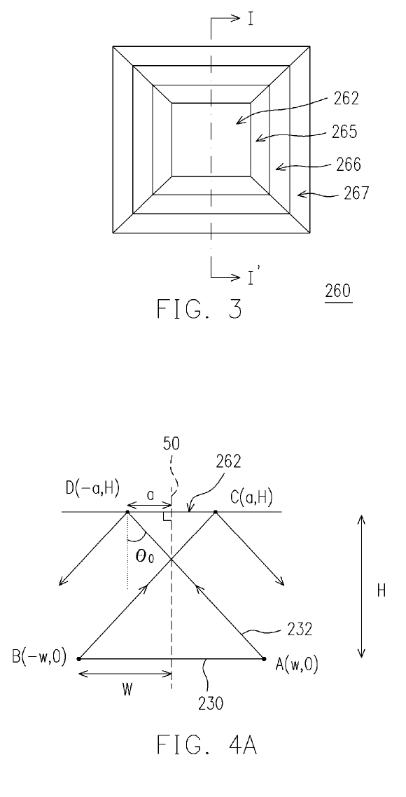

FIG. 3 schematically shows a top view of the lens in the first embodiment of the present invention. Referring to FIGS. 2 and 3, in this embodiment the contours of the top surface 262 and bottom surface 264 of the lens 260 and contours of sections of banding surfaces 265, 266, and 267 which are parallel with bottom surface 264 can be circles, or can be similar to the contour of interface where the organic light emission layer 230 and transparent electrode layer 240 are connected. For instance, when the contour of the interface where the organic light emission layer 230 and transparent electrode layer 240 are connected is a rectangle, the contours of the top surface 262 and bottom surface 264 of the lens 260 and contours of sections of banding surfaces 265, 266, and 267 which are parallel with bottom surface 264 are rectangles (as shown in FIG. 3), for example. Besides, the contour size of bottom surface 264 of the lens 260 is identical to that of the contour of interface where the organic light emission layer 230 and transparent electrode layer 240 are connected, for example. Moreover, the section of the lens 260 shown in FIG. 2 is taken along the line I-I′ in FIG. 3. This section is perpendicular to the bottom surface 264 of the lens 260, and also it passes through the center of the rectangle and is parallel to one edge of the rectangle.

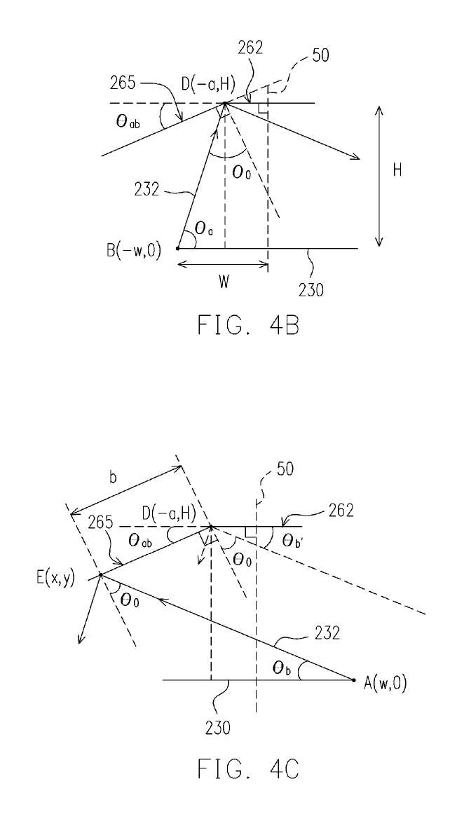

Hereafter, the designing principle for the shape of the lens 260 is described. Referring to FIGS. 4A to 4C, the design method of the shape of the lens shown in FIG. 2 is sketched. In the present embodiment, determination of the shape of the lens 262 can be performed by the steps of figuring out the width of the top surface 262 first, and then calculating the inclination degree of each banding surface 265 and the shortest distance from the highest point to the lowest point. Here, since the thicknesses of the organic light emission layer 230, metal electrode 220 and transparent electrode layer 240 are farther smaller than the thickness of the passivation layer 250, the refraction of light 232 between the organic light emission layer 230 and the transparent electrode layer 240 is not taken into account in calculating. Furthermore, for convenience of description, it's assumed that the refraction indices of the passivation layer 250 and the lens 260 are identical and that the organic light emission layer 230 is closely adjacent to underside of the passivation layer 250. Meanwhile, the contour of this organic light emission layer 230 is a rectangle with the edge of 2 w long.

How to determine the maximum width of top surface 262 of the lens 260 is described in the following description. Referring to FIG. 4A, the axis 50 passes through the center of the organic light emission layer 230. The total reflection angle θ₀=sin⁻¹(1/n) between the lens 260 and the air can be calculated according to Snell's Law where n is the reflection indices of the passivation layer 250 and that of the lens 260. Next, the step of finding out the location (i.e. the point D) where the angle of incidence on top surface 262 for light 232 emitting from the point A of the organic light emission layer 230 is identical to the total reflection angle θ₀ is performed. Then, values of a=H tan θ₀−w and the maximum width 2 a of top surface 262 are calculated according to tan θ₀=(a+w)/H (where H is the sum of thicknesses of lens 260 and passivation layer 250). Namely, the width of the top surface 262 can be smaller than or equal to 2 a such that the angle of incidence on top surface 262 for light 232 emitted by the organic light emission layer 230 is smaller than or equal to the total reflection angle for reducing the possibility of the total reflection.

Still referring to FIG. 4B, after determination of the width of the top surface 262, the calculation of the maximum angle θ_{ab} between the banding surface 265 and top surface 262 is performed. The defining method is to consider the lights 232 emitted from the point B of the organic light emission layer 230, and to increase gradually the angle between the banding surface 265 and top surface 262 until that the incident angle of light 232 on the point D of the banding surface 265 equals the total reflection angle θ₀. Consequently, this angle between the banding surface 265 and top surface 262 is the maximum angle θ_{ab}, where θ_{ab}=tan⁻¹ [H/(w−a)]+θ₀−90°.

Referring to FIG. 4C, after determining the maximum angle θ_{ab} between the banding surface 265 and the top surface 262, the maximum value of the shortest distance between the highest point and the lowest point of banding surface 265, i.e. the value of the maximum length b, is given. The defining method is to consider the position (i.e. the point E) where the incident angle of the light 232 emitted from the point A of the organic light emission layer 230 equals the total reflection angle θ₀, where b=[H−tan θ_{b}(a+w)]/(sin θ_{ab}+tan θ_{b}cos θ_{ab}) and θ_{b}=90°−θ₀−θ_{ab}.

Then, the methods described in FIGS. 4B and 4C are repeated to sequentially determine the shapes of banding surfaces 266 and 267, so that the shape of the lens 260 shown in FIG. 2 is obtained. Since at the sections of the lens 260 shown in FIG. 2, the incident angles of the lights 232 emitted from the organic light emission layer 230, on top surface 262 of lens 260 and on each point of the banding surface 265, 266 and 267, are all smaller than or equal to the total reflection angle θ₀, the light 232 can emit from the lens 260. Consequently, the organic electroluminescence device 200 of the present embodiment has a higher coupling efficiency.

It's worthy to note that, when the refraction indices of the lens 260 and the passivation layer 250 are different, the refraction of the light 232 between the lens 260 and the passivation layer 250 needs to be considered. Besides, when it's desired that the contours of top surface 262 and bottom surface 264 of the lens 260 and contours of sections of banding surfaces 265, 266, and 267 which are parallel to bottom surface 264 are designed as circular, the shape of the lens also can be designed by using the methods mentioned above.

FIG. 5 schematically shows a cross-sectional view of another organic electroluminescence device according to the first embodiment of the present invention. Referring to FIG. 5, the organic electroluminescence device 200a of the present invention is similar to the organic electroluminescence device 200 in FIG. 2, and the difference is that the organic electroluminescence device 200a further comprises a hole transport layer 270 and an electron transport layer 280. The hole transport layer 270 is disposed between the metal electrode layer 220 and the organic light emission layer 230, and electron transport layer 280 disposed between the transparent electrode layer 240 and the organic light emission layer 230. It's worthy to note that, in the organic electroluminescence device 200 the hole transport layer 270 or the electron transport layer 280 can be neglected. Alternatively, if the metal electrode layer 220 is a cathode and the transparent electrode layer 240 is an anode, the hole transport layer 270 is disposed between the transparent electrode layer 240 and the organic light emission layer 230, and electron transport layer 280 disposed between the metal electrode layer 220 and the organic light emission layer 230.

The electrons from the transparent electrode layer 240 pass through the electron transport layer 280 and transmit to the light emission layer 230, and the holes from the metal electrode layer 220 are prevented from directly transmitting to the transparent electrode layer 240 by the electron transport layer 280. The holes from the metal electrode layer 220 pass through the hole transport layer 270 and transmit to the light emission layer 230, and the electrons from the transparent electrode layer 240 are prevented from directly transmitting to the metal electrode layer 220 by the hole transport layer 270.

### The Second Embodiment

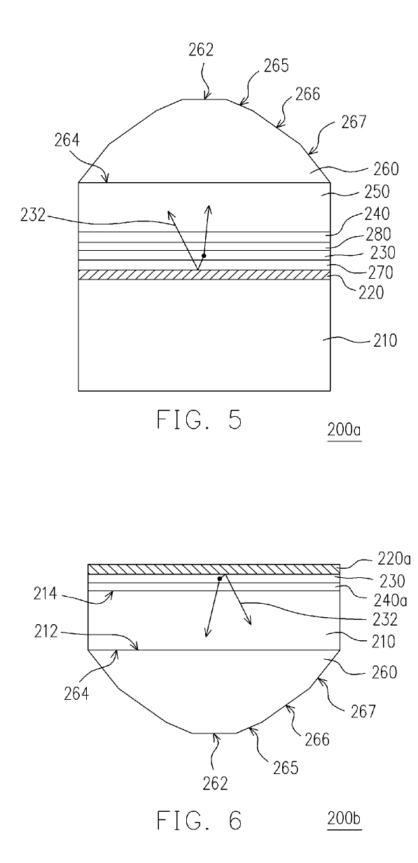

FIG. 6 schematically shows a cross-sectional view of another organic electroluminescence device according to the second embodiment of the present invention. Different from the organic electroluminescence devices 200 and 200a for the first embodiment, the organic electroluminescence device 200b of the present embodiment is the bottom-emission organic electroluminescence device and comprises a substrate 210, a transparent electrode layer 240a, an organic light emission layer 230, a metal electrode layer 220a, and a lens 260. The transparent electrode layer 240a is disposed on a first surface 212 of the substrate 210, and the organic light emission layer 230 is disposed on the transparent electrode layer 240a and is suitable for emitting a light 232. Further, the metal electrode layer 220a is disposed on the organic light emission layer 230, and the lens 260 is disposed on a second surface 214 of the substrate 210 where the second surface 214 is opposite to the first surface 212. Additionally, the shape of the lens 260 is similar to that in the first embodiment, so it will not be described again herein.

In the organic electroluminescence device 200b mentioned above, the transparent electrode layer 240a is an anode and the metal electrode layer 220a is a cathode, for example. As the lights 232 from the organic light emission layer 230 that scatter upwards will be reflected by the metal electrode layer 220a, this organic electroluminescence device 200b is a bottom-emission organic electroluminescence device. In addition, the materials of the lens 260, the substrate 210 and the transparent electrode layer 240a are similar to those in the first embodiment, as referred in previous descriptions.

Similar to the first embodiment, when the contour of the interface where the organic light emission layer 230 and the transparent electrode layer 240a are connected is a rectangle, the incident angles of the lights 232 emitted from the organic light emission layer 230 on top surface 262 and on each banding surface 265, 266 and 267 can be smaller than or equal to the total reflection angle between the lens 260 and the air, at the sections perpendicular to the bottom of the lens 260, through the center of the rectangle and parallel with an edge of the rectangle.

In the present embodiment, a hole transport layer (not shown) can be disposed between the transparent electrode layer 240a and the organic light emission layer 230, or an electron transport layer (not shown) can be disposed between the metal electrode layer 220a and the organic light emission layer 230. Alternatively, if the metal electrode layer 220a is an anode and the transparent electrode layer 240a is a cathode, the hole transport layer is disposed between the metal electrode layer 220a and the organic light emission layer 230, and electron transport layer disposed between the transparent electrode layer 240a and the organic light emission layer 230.

In summary, in the organic light emission device provided by the present invention, because the incident angles of the lights emitting from the organic light emission layer on top surface of the lens and the banding surfaces are smaller than the total reflection angle between the lens and the air so that all lights can couple out. Consequently, the organic light emission device of the present invention can have a higher coupling efficiency.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An organic electroluminescence device, comprising:
a substrate;
a metal electrode layer disposed on the substrate;
an organic light emission layer disposed on the metal electrode layer;
a transparent electrode layer disposed on the organic light emission layer;
a passivation layer disposed on the transparent electrode layer; and
a lens disposed on the passivation layer, the lens having a top surface and a bottom surface opposite to each other and a plurality of banding surfaces connected between the top surface and the bottom surface and forming a discontinuous surface, wherein, the banding surfaces are inclined and the angle between the bottom surface and the banding surface closer to the bottom surface is the largest.

2. The organic electroluminescence device according to claim 1, wherein the contour of an interface where the organic light emission layer and the transparent electrode layer are connected is a rectangle, the contour of the top surface and the bottom surface of the lens is a circle, and the contour of a section of each of the banding surfaces parallel with the bottom surface is a circle.

3. The organic electroluminescence device according to claim 2, wherein incident angles of the lights emitted from the organic light emission layer on the top surface and on each of the banding surfaces are smaller than or equal to the total reflection angle between the lens and the air at a section which is perpendicular to the bottom of the lens, through the center of the rectangle and parallel with an edge of the rectangle.

4. The organic electroluminescence device according to claim 1, wherein the contour of an interface where the organic light emission layer and the transparent electrode layer are connected is a rectangle, the contour of the top and the bottom of the lens is a rectangle, and the contour of a section of each of the banding surfaces parallel with the bottom face is a rectangle.

5. The organic electroluminescence device according to claim 4, wherein incident angles of the lights emitted from the organic light emission layer on the top surface and on each of the banding surfaces are smaller than or equal to the total reflection angle between the lens and the air at a section which is perpendicular to the bottom of the lens, through the center of the rectangle and parallel with an edge of the rectangle.

6. The organic electroluminescence device according to claim 1, wherein the material of the lens is polycarbonate (PC) or polymethyl methacrylate (PMMA).

7. The organic electroluminescence device according to claim 1, further comprising a hole transport layer disposed between the metal electrode layer and the organic light emission layer.

8. The organic electroluminescence device according to claim 1, further comprising a hole transport layer disposed between the transparent electrode layer and the organic light emission layer.

9. The organic electroluminescence device according to claim 1, further comprising an electron transport layer disposed between the transparent electrode layer and the organic light emission layer.

10. The organic electroluminescence device according to claim 1, further comprising an electron transport layer disposed between the metal electrode layer and the organic light emission layer.

11. An organic electroluminescence device, comprising:
a substrate;
a transparent electrode layer disposed on a first surface of the substrate;
an organic light emission layer disposed on the transparent electrode layer;
a metal electrode layer disposed on the organic light emission layer; and
a lens disposed on a second surface of the substrate, the second surface being opposite to the first surface, and the lens having a top surface and a bottom surface opposite to each other and a plurality of banding surfaces connected between the top surface and the bottom surface and forming a discontinuous surface, wherein, the banding surfaces are inclined and the angle between the banding surface closer to the bottom surface and the bottom surface is the largest.

12. The organic electroluminescence device according to claim 11, wherein the contour of the interface where the organic light emission layer and the transparent electrode layer are connected is a rectangle, the contour of the top surface and the bottom surface of the lens is a circle, and the contour of a section of each of the banding surfaces parallel with the bottom surface is a circle.

13. The organic electroluminescence device according to claim 12, wherein incident angles of the lights emitted from the organic light emission layer on the top surface and on each of the banding surfaces are smaller than or equal to the total reflection angle between the lens and the air at a section which is perpendicular to the bottom of the lens, through the center of the rectangle and parallel with an edge of the rectangle.

14. The organic electroluminescence device according to claim 11, wherein the contour of the interface where the organic light emission layer and the transparent electrode layer are connected is a rectangle, the contour of the top surface and the bottom surface of the lens is a rectangle, and the contour of a section of each of the banding surfaces parallel with the bottom surface is a rectangle.

15. The organic electroluminescence device according to claim 14, wherein incident angles of the lights emitted from the organic light emission layer on the top surface and on each of the banding surfaces are smaller than or equal to the total reflection angle between the lens and the air at a section which is perpendicular to the bottom of the lens, through the center of the rectangle and parallel with an edge of the rectangle.

16. The organic electroluminescence device according to claim 11, wherein the material of the lens is polycarbonate (PC) or polymethyl methacrylate (PMMA).

17. The organic electroluminescence device according to claim 11, further comprising a hole transport layer disposed between the metal electrode layer and the organic light emission layer.

18. The organic electroluminescence device according to claim 11, further comprising a hole transport layer disposed between the transparent electrode layer and the organic light emission layer.

19. The organic electroluminescence device according to claim 11, further comprising an electron transport layer disposed between the transparent electrode layer and the organic light emission layer.

20. The organic electroluminescence device according to claim 11, further comprising an electron transport layer disposed between the metal electrode layer and the organic light emission layer.
